(19) United States
(12) Patent Application Publication
(10) Pub. No.: US 2026/0257710 A1
(43) Pub. Date: Sep. 3, 2026

(54) VARIABLE WHEEL POSITION WHEELBARROW AND METHOD FOR HANDLING WITH WHEELBARROW FOR THE PURPOSE OF CHANGING OF THE WHEEL POSITION

(71) Applicant: PRODUCT DESIGN S. R. O., Bratislava (SK)

(72) Inventor: František PALDAN, Bratislava (SK)

(21) Appl. No.: 18/993,758

(22) PCT Filed: Jul. 13, 2023
(86) PCT No.: PCT/SK2023/050022

§ 371 Date: Jan. 13, 2025

(30) Foreign Application Priority Data
Jul. 15, 2022 (SK) PP 75-2022

(51) Int. Cl. B62B 1/20

(52) U.S. Cl. CPC B62B 1/20; B62B 2301/05; B62B 2301/10

(57) ABSTRACT

The wheelbarrow with swing mounted supports and variable wheel position allows by changing the position of at least one wheel and the loaded wheelbarrow. By displacing at least one wheel under the body, the vertical load on the handles of the wheelbarrow in transport is reduced. The basis of solution is at least one support swinging mounted on the frame and swinging mounted at least one carrier. The shaft of at least one wheel is mounted in at least one carrier. The lower portions at least of one support are connected to the upper portions at least of one carrier by draw bars through the pivot pins. Horizontal movement of the frame overturns at least one carrier from one position to the other position limited by means of stops and thereby displaces at least one wheel more in front of the body or more under the body.

### FIELD OF THE INVENTION

The proposed solution of the invention relates to the construction of wheelbarrows with one or more wheels having a common axis of rotation, wherein the proposed mechanism changes the position of wheel between the position in front of the body and the position under the body. The invention also relates to handling with the wheelbarrow in order to change the wheel position. In general, wheelbarrows are simple means of transport used for transport of loads over short distances using the lever principle. The invention falls into the field of small-scale mechanisation in the building industry.

### BACKGROUND OF THE INVENTION

The classic wheelbarrow, as it is known in the prior state of the art, consists of a body, a frame terminated by handles, two supports, and a wheel. The wheel is rotatable on the frame on the opposite side to the handles. The supports are rigidly connected to the frame approximately in the middle of the length of frame. The body is fixed on the frame between the wheel and the supports, thus ensuring the stability of the standing wheelbarrow. The disadvantage is the large vertical force load on the handles of the wheelbarrow from the weight of the load being carried and the need for a large force to unload the load in front of the wheelbarrow wheel In the state of the art, document KR 20110005670A discloses a known solution of a wheelbarrow which allows a wheel to be moved in front of the body and under the body. The wheel is moved in a horizontal movement using both a carrier and stops supporting on the frame of the wheelbarrow itself, but the supports are fixed and are not used when changing the position of wheel. When the wheel is re-positioned, the brake on one of the frame handles is necessarily used when the brake is applied and the wheel is blocked and then, when the wheelbarrow handles are raised, a considerable force in the horizontal direction is then required to move the wheelbarrow frame, even with the loaded body.

### SUMMARY OF THE INVENTION

The above-mentioned deficiencies of classical wheelbarrows known in the prior state of the art are eliminated by the proposed design of a wheelbarrow with a variable wheel position according to invention, the essence of which consists in the fact that it comprises at least one wheel, at least one carrier and at least one support, wherein the supports are mounted swinging on the frame of the wheelbarrow in a plane perpendicular to the axis of the wheel shaft of wheel of the wheelbarrow and around the axis of the support mounting parallel to the axis of the shaft of wheel.

Also on the frame of wheelbarrow, in the carrier sleeve around the carrier mounting axis parallel to the wheel axis, there are swinging carriers bearing the wheel shaft. The wheel shaft is mounted in the shaft mounting sleeve. The supports are connected to the carriers by rods through the pivot pins, which creates a leverage effect that aids the turnover process. The swing of the carriers is limited by stops in both the first and second positions, whereby in the first position, i.e. the position where the wheel is more under the body, the axial distance of the wheel shaft axis from the axis of the carrier is smaller than their axial distance in the second position, i.e. the position where the wheel is more in front of the body.

It is advantageous if the swinging motion of the carriers is limited by stops within a range of approximately +15° from the vertical plane. It is also advantageous if the draw bar is mounted through the pivot pin at half of length of the support located further away from the axis of the support mounting, or particularly advantageously as far as possible from the axis of the support mounting, and is mounted on the carrier through the pivot pin closer to the axis of the carrier mounting, whereby the leverage effect is maximised and the whole turnover process becomes easier, even with a wheelbarrow loaded with a heavy load.

Particularly advantageous is a wheelbarrow arrangement in which the wheelbarrow has at least one wheel mounted between two carriers and two supports, wherein each support is terminated by the foot or the two supports are connected by the common foot, optionally they are connected by the crossbar.

Alternatively, the wheelbarrow preferably comprises two carriers arranged between the two wheels such that the carriers are mounted on either side of the wheelbarrow in carrier mounting sleeves on the frame of the wheelbarrow, and share the common shaft mounting sleeve. The wheel shafts are mounted at each end of the shaft mounting sleeves. Preferably, each support may be terminated by the foot or the two supports may be connected by the common foot. Advantageously, the single common shaft may also be used. Alternatively, the wheelbarrow can be arranged with one carrier or with one support.

The solution is also based on method of handling with wheelbarrow for the purpose of changing of the position of wheel, which includes the following steps:
horizontal displacement of the frame of wheelbarrow, in one direction perpendicular to the axis of the shaft at least of one wheel, when at least one support bears at least part of the weight of wheelbarrow and at the same time when at least one wheelbarrow carrier is in the first position, which causes deflection at least of one support in the plane perpendicular to the axis of the shaft at least of one wheel, and thus turnover at least of one carrier from the first position to the second position, and displacement at least of one wheel;
horizontal displacement of the frame of wheelbarrow, in the opposite direction perpendicular to the axis of the shaft at least of one wheel, when at least one support bears at least part of the weight of wheelbarrow and at the same time when at least one wheelbarrow carrier is in the second position, which causes deflection at least of one support in the plane perpendicular to the axis of the shaft at least of one wheel and thus turnover at least of one carrier from the second position to the first position and displacement at least of one wheel.

Preferably, the horizontal displacement of the frame is accompanied by pushing downwards on the handles of wheelbarrow frame in contact with the ground at least of one of the supports for the purpose of relieving at least one wheel of wheelbarrow.

The advantages of the variable wheelbarrow and the method of handling with wheelbarrow for the purpose of changing of the position of the wheel are evident from the effects by which it manifests itself externally. The originality of the wheelbarrow according to the invention lies in the fact that the design according to the present invention enables, by the proposed procedure, to easily change the wheel position from the wheel position more in front of the body to the wheel position more under the body and vice versa, even when the wheelbarrow is loaded with a load.

By displacing of wheel more under the body, the distance of the wheel axis from the centre of gravity of the whole wheelbarrow is reduced, thus reducing the vertical load on the handles of wheelbarrow when transporting the load as well as manoeuvrability with it. This will also reduce the force required for overturning the load.

By displacing of wheels more in front of the body, a higher stability of the stationary wheelbarrow is ensured, which is especially advantageous when loading a load or a burden. Thus, for example, it is possible to load a wheelbarrow, possibly with an unevenly distributed load or burden, in a position where the wheel is more in front of the body, without fear of it turnover, and then, with the wheelbarrow loaded in this way, to move the wheel more under the body and facilitate further handling with wheelbarrow. The range of swing of the carriers is limited by the stops, which also limit the range of swing of the carriers due to the connection of the supports to the carriers and the draw bars, preferably to approximately ±15° from the vertical plane as described above.

Thus, the construction solution of wheelbarrow according to the present invention allows to horizontally move the frame forward or backward, preferably while pushing the handles downward for the reason of relieving of the wheel, as a result of contact of the supports with ground and their connection by draw bars with the carriers, to overturn the carriers from one to the other by means of stops of limited position and thus to move the wheel more in front of the body, or more under the body even when the wheelbarrow is loaded with a burden. Pushing on the handles and relieving the wheel simplifies the whole process of turnover of the carriers. Any increased rolling resistance with a smaller diameter wheel can be advantageously eliminated by using a wheel with a wider air-pressurised tyre and, in particular, a motor driven wheel.

### BRIEF DESCRIPTION OF THE DRAWING

The wheelbarrow with variable wheel position and the method of handling with wheelbarrow for the purpose of changing of the wheel position according to invention is further explained by means of the drawings.

### EXAMPLES OF EMBODIMENTS OF THE INVENTION

### Example 1

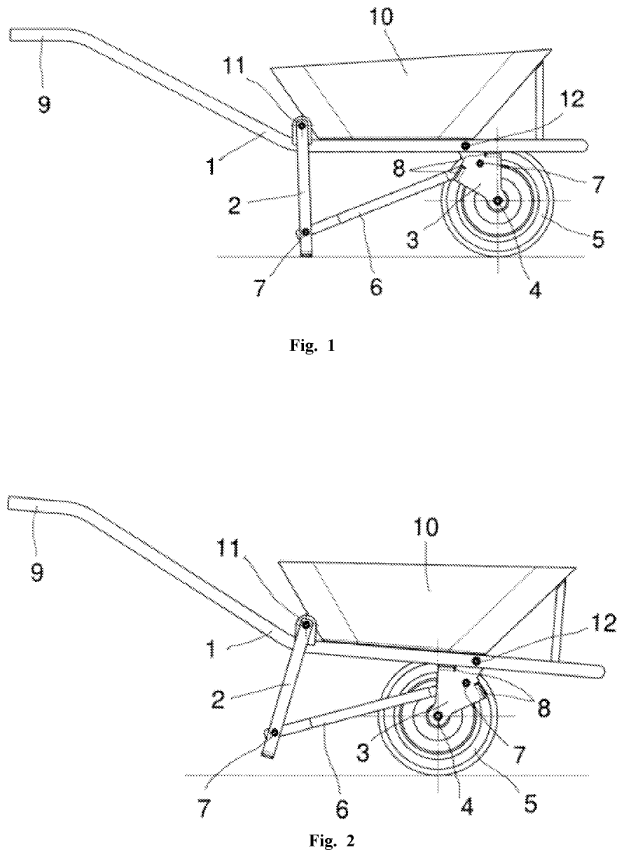

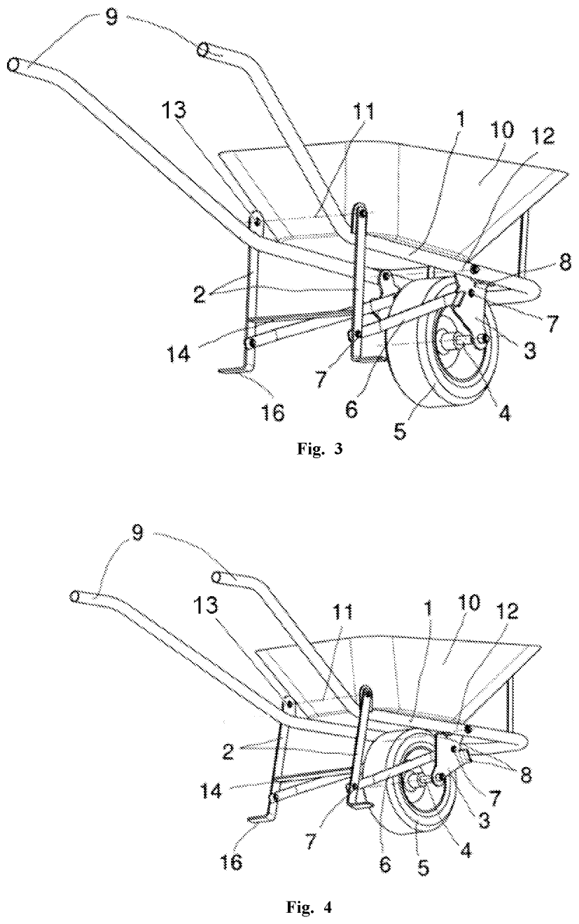

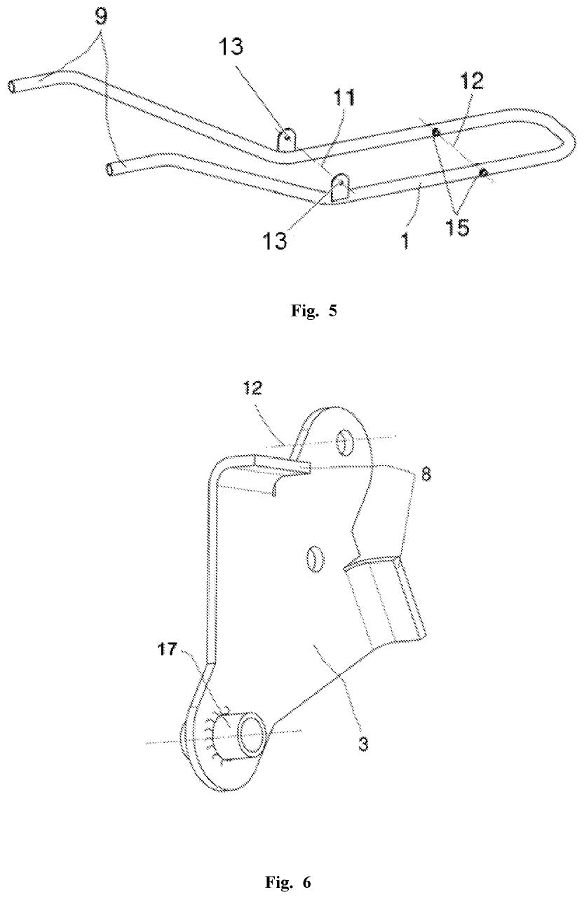

In this example embodiment of the invention, the wheelbarrow with variable position of one wheel is described, which is shown in FIGS. 1 to 6. On the frame 1, preferably made by bending of a tube, and terminated by handles 9, on both sides of the frame 1 are welded stirrups 13 of the support 2 mounting for swinging connection of the supports 2 in the axis 11 of the support 2 mounting.

On the frame 1, two sleeves 15 of the carrier 3 mounting are welded for swinging connection of the two carriers 3 in the axis 12 of the carrier 3 mounting. The body 10 is fixed on the frame 1. On both sides of the wheelbarrow, a carrier 3, which is preferably made of sheet metal, is mounted in the sleeve 15 of the carrier 3 mounting. It has two stops 8 formed by bending and the welded sleeve 17 for mounting the shaft 4 of wheel 5. The swinging movement of the carriers 3 is limited by the seating of the stops 8 on the frame 1. The supports 2 are preferably made of a flat bar with bending formed feet 16 and are preferably connected by the crossbar 14. In the lower part of the supports 2 and the upper part of the carriers 3 there are holes for pivot pins 7, through which the draw bar 6 connecting the supports 2 to the carriers 3 is connected. The draw bars 6 are preferably made of a flat bar and are shaped so as to eliminate the difference in spacing of the supports 2 and the spacing of the carriers 3.

In an alternative implementation, the supports 2 have one common foot 16, and preferably do not have the crossbar 14, but this is not shown in the figure.

### Example 2

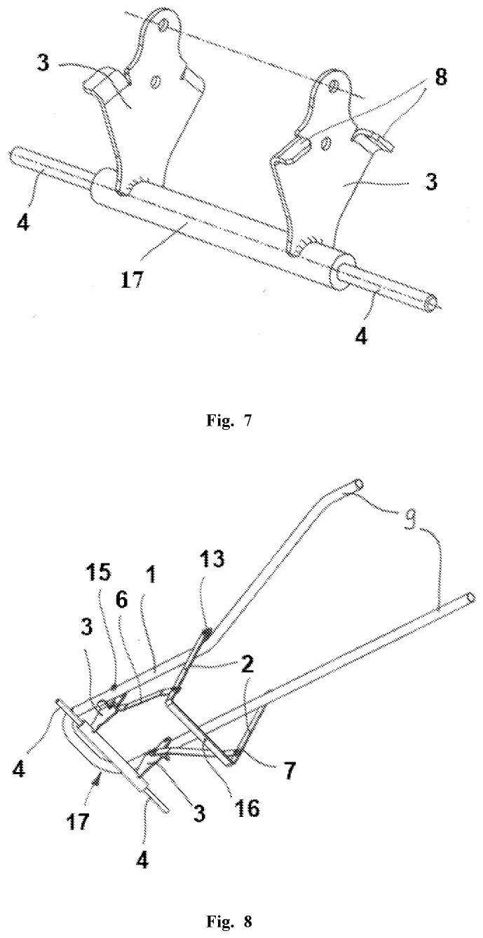

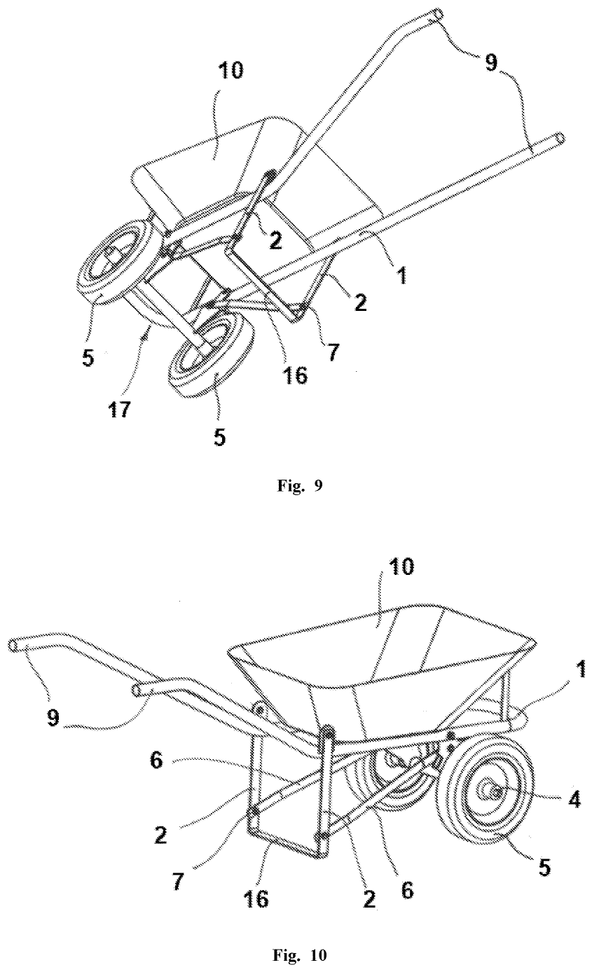

In this example embodiment of the invention, a wheelbarrow with variable position of two wheels is described, which is shown in FIGS. 7 to 10. On the frame 1, preferably made by bending of a tube, and terminated by handles 9, stirrups 13 of a support 2 mounting are welded on both sides of the frame 1 for swinging connection of the two supports 2 in the axis 11 of the support 2 mounting.

On the frame 1, two sleeves 15 of the carrier 3 mounting are welded for swinging connection of the two carriers 3 in the axis 12 of the carrier 3 mounting. The body 10 is fixed on the frame 1. In this case, on both sides of the wheelbarrow, the carriers 3 are mounted in the sleeves 15 of the carrier 3 mounting on the frame 1 of the wheelbarrow, which have a common sleeve 17 of the shaft 4 mounting. At both ends of the sleeve 17 are shafts 4 for mounting of the wheels 5. The two carriers 3 and the common sleeve 17 for the shafts 4 are thus placed between the two wheels 5.

The swinging movement of the carriers 3 is limited by the seating of the stops 8 on the frame 1. The supports 2 are preferably made of a flat bar with the bending advantageously formed by the common foot 16. In the lower part of the supports 2 and in the upper part of the carriers 3, there are holes for pivot pins 7 through which a draw bar 6 connecting the supports 2 to the carriers 3 is connected. The draw bars 6 are preferably made of a flat bar and are shaped so as to eliminate the difference in spacing of the supports 2 and the spacing of the carriers 3. In an alternative implementation, the supports 2 have separate footings 16 and preferably also the crossbar 14, or alternatively have only the crossbar 14, which is not shown in the figure.

### Example 3

In this example of embodiment of the invention, method of handling a wheelbarrow for the purpose of changing of the position of wheel is described using the wheelbarrow having a variable position at least of one wheel, comprising the steps provided below. In an initial position, if the at least one wheel 5 of the wheelbarrow is in the first position and if the weight of the wheelbarrow lies at least partially on the at least one support 2, horizontal displacement of the frame 1 of the wheelbarrow by the handles 9 in a direction perpendicular to the axis of the shaft 4 at least of one wheel 5 causes deflection at least of one support 2 in the plane perpendicular to the axis of the shaft 4 at least of one wheel 5 and thereby turnover at least of one carrier 3 from the first position to the second position and displacement of wheel 5.

Similarly, when at least one wheel 5 of the wheelbarrow returns from the second position to the first position, if the weight of the wheelbarrow lies at least partially on the at least one support 2, the horizontal displacement of the frame 1 of the wheelbarrow by the handles 9 in the opposite direction perpendicular to the axis of the shaft 4 at least of one wheel 5 causes the deflection at least of one support 2 in the plane perpendicular to the axis of the shaft 4 at least of one wheel 5 and thus also the turnover at least of one carrier 3 from the second position to the first position, and the displacement of the wheel 5. In both cases, it is advantageous if, when moving the frame, the handles 9 of the frame 1 of the wheelbarrow are simultaneously pushed downwards in contact with the ground at least of one of the supports 2 in order to relieve at least one wheel 5 of the wheelbarrow.

Briefly, the displacement at least of one wheel 5 from a position more in front of the body 10 to a position more under the body 10 is done by horizontally displacing the frame 1 away from itself, preferably while simultaneously pushing downwards on the handles 9 of the frame 1 to relieve at least one of wheels 5.

At least one wheel 5 is held in its current position in front of, or under, the body 10 by the force of gravity. For the functionality of the proposed solution, it is advantageous that the range of swinging at least of one support 2 is limited in area close to the vertical plane. Otherwise, the force required to move the frame 1 horizontally would increase in the process of changing of the position at least of one wheel 5.

### INDUSTRIAL APPLICABILITY

The industrial applicability of the wheelbarrow with variable wheel position according to invention is in the building industry, agriculture and gardening.

### LIST OF REFERENCE NUMBER

1 Frame
2 Support
3 Carrier
4 Wheel shaft
5 Wheel
6 Draw bar
7 Pivot pin
8 Stop
9 Handle
10 Body
11 Axis of support mounting
12 Axis of carrier mounting
13 Stirrup for support mounting
14 Crossbar
15 Sleeve of carrier mounting
16 Support foot
17 Sleeve of shaft mounting

1. A wheelbarrow with a variable position at least of one wheel with a frame and body, comprising at least one carrier with a sleeve for mounting a shaft and at least one support, wherein
the shaft at least of one wheel is mounted in the sleeve for mounting the shaft at least of one carrier mounted on the frame swinging around a second axis parallel to an axis of the shaft at least of one wheel, where
at least one support is mounted on the frame swinging in a plane perpendicular to the axis of the shaft at least of one wheel around a first axis parallel to the axis of the shaft at least of one wheel, where
at least one support is connected by a draw bar to at least one carrier through athe pivot pins, where
a swing at least of one carrier is limited by a stops in the first position and in the second position, wherein in the first position the axial distance of the axis of the shaft at least of one wheel from the first axis is smaller than their axial distance in the second position, while
the arrangement at least of one support, at least of one wheel and at least of one carrier is such that while at least one support is at least partially bearing the weight of the wheelbarrow, at least one carrier is in the first position, the horizontal movement of the frame of the wheelbarrow in one direction perpendicular to the axis of the shaft at least of one wheel causes the deflection at least of the support in the plane perpendicular to the axis of the shaft at least of one wheel and thus a turnover at least of one carrier from the first position to the second position and the displacement at least of one wheel, wherein
as long as at least one support bears at least partially the weight of the wheelbarrow and at least one carrier is in the second position, horizontal movement of the frame of the wheelbarrow in the opposite direction perpendicular to the axis of the shaft at least of one wheel causes deflection at least of one support in the plane perpendicular to the axis of the shaft at least of one wheel and thus turnover at least of one carrier from the second position to the first position and displacing at least of one wheel.

2. The wheelbarrow according to claim 1, wherein the draw bar is attached through the pivot pin at a half of length at least of one support spaced further from the first axis at least of one support, and on at least one carrier is attached through the pivot pin at a position whose distance from the second axis at least of one carrier is smaller than its distance from the axis of the shaft at least of one wheel.

3. The wheelbarrow according to claim 1, further comprising one wheel mounted between two carriers, and two supports, each support terminated by a foot.

4. The wheelbarrow according to claim 1, further comprising one wheel mounted between two carriers, and two supports, the supports are connected by the common foot.

5. The wheelbarrow according to claim 1, further comprising two carriers mounted between two wheels, and two supports, each support is terminated by the foot.

6. The wheelbarrow according to claim 1, further comprising two carriers mounted between two wheels, and two supports, wherein the supports are connected by the common foot.

7. A method for handling with the wheelbarrow according to claim 1, comprising:
if weight of the wheelbarrow lies at least partially at least on one support and, at the same time, if at least one wheelbarrow carrier is in the first position, horizontal displacement of the frame of the wheelbarrow in one direction perpendicular to the axis of the shaft at least of one wheel, which causes deflection at least of one support and thus turnover at least of one carrier from the first position to the second position and displacement at least of one wheel. further comprising:
if at least one support bears at least partially the weight of the wheelbarrow and, at the same time, if at least one carrier of the wheelbarrow is in the second position, the horizontal displacement of the frame of the wheelbarrow in the opposite direction perpendicular to the axis of the shaft at least of one wheel, which causes the deflection at least of one support and thus the turnover at least of one carrier from the second position to the first position and the displacement at least of one wheel.

8. The method according to claim 7, further comprising:
pushing downwards on the handles of the frame of the wheelbarrow when at least one of the supports is in contact with the ground to relieve at least one wheel of the wheelbarrow;
